(19) United States
(12) Patent Application Publication
(10) Pub. No.: US 2020/0410460 A1
(43) Pub. Date: Dec. 31, 2020

(54) METHOD AND SYSTEM FOR ASSESSING FUTURE EXECUTION OF A SMART CONTRACT BASED ON PREVIOUS EXECUTIONS ON A BLOCKCHAIN-BASED PLATFORM

(71) Applicant: VALID NETWORK LTD, Beer Sheva (IL)

(72) Inventors: Kfir NISSAN, Haifa (IL); Gilad EISENBERGER, Haifa (IL)

(73) Assignee: VALID NETWORK LTD, Beer Sheva (IL)

(21) Appl. No.: 16/977,745

(22) PCT Filed: Mar. 18, 2019
(86) PCT No.: PCT/IL2019/050297

§ 371 Date: Sep. 2, 2020

Related U.S. Application Data
(60) Provisional application No. 62/644,516, filed on Mar. 18, 2018.

(51) Int. Cl. G06Q 20/06; G06K 9/62; G06Q 20/38

(52) U.S. Cl. CPC G06Q 20/065; G06K 9/6215; G06Q 2220/00; G06Q 20/389; G06Q 20/382

(57) ABSTRACT

A system comprising a blockchain computer system that hosts an original smart contract and stores and maintains a blockchain ledger, and an off-chain computer system that is configured to automatically perform an off-chain comparison between the behavior of the original smart contract and a new smart contract and accordingly to provide an insight.

### FIELD OF THE INVENTION

The present invention relates to the field of decentralized systems. More particularly, the invention relates to a method of evaluating the behavior of logic written in software code such as smart contracts or other block-chain based agreements.

### BACKGROUND OF THE INVENTION

A smart contract is a computer code running on top of a decentralized system such as blockchain, containing a set of rules under which the parties to that smart contract agree to interact with each other. If and when the pre-defined rules are met, the agreement is automatically enforced. The smart contract code facilitates, verifies, and enforces the negotiation or performance of an agreement or transaction. It is the simplest form of decentralized automation. Actually, in a smart contract a decentralized ledger of the decentralized system is used and results in ledger feedback such as transferring money and receiving the product or service.

For example, in some aspects, a smart contract is a mechanism that may involve digital assets and two or more parties, where some or all of the parties deposit assets into the smart contract and the assets automatically get redistributed among those parties according to a formula based on certain data, which is not known at the time of contract initiation.

However, a major disadvantage of the smart contracts are the fact that once it is used (i.e., deployed into the decentralized system), it cannot be changed, and if there are some aspects that are not taken into account when coding the smart contract, these aspects remains untreated. Moreover, if there was a mistake or bug in the code of the smart contract, it is impossible to change the code and to execute a benign code of the smart contract.

It is an object of the present invention to provide a system which is capable of evaluating a new version of a smart contract based on the actual behavior of a previous version of a smart contract that was used before in a blockchain system.

It is another object of the present invention to provide a system which is capable of detecting the behavior of a new version of a smart contract before it is deployed into a blockchain system.

Other objects and advantages of the invention will become apparent as the description proceeds.

### SUMMARY OF THE INVENTION

A system for assessing future execution of a smart contract based on previous executions on a blockchain-based platform, comprising:

A blockchain computer system that hosts an original smart contract and stores and maintains a blockchain ledger; and

An off-chain computer system that is not part of the blockchain system and does not store or maintain the blockchain ledger, the off-chain system is configured to automatically perform an off-chain comparison between the behavior of the original smart contract and a new smart contract. Wherein the off-chain computer system having at least one application that is configured to retrieve transaction data together with the original smart contract from the blockchain ledger of the blockchain computer system, to identify at least one base path of the original smart contract and accordingly to create a base path that includes an initial state of an original transaction of the identified base path, to simulate a transaction using the initial state of the original transaction of the identified base path, but with instructions of the new smart contract, to decide whether the behavior of the original and new smart contracts identical or differ, and accordingly to generate an insight.

According to an embodiment of the invention, the off-chain computer system is implemented by using one or more processors, a memory and one or more persistent storage devices that allow the off-chain computer system to store data and host one or more applications and communicate with the blockchain computer system over a communications path and interact with the blockchain ledger in order to reproduce a transaction's execution by the off-chain computer system.

A method for assessing future execution of a smart contract based on previous executions on a blockchain-based platform, comprising:

Providing a blockchain computer system that hosts an original smart contract and stores and maintains a blockchain ledger; and

Providing an off-chain computer system that is not part of the blockchain system and does not store or maintain the blockchain ledger, the off-chain system having at least one an application that is configured to perform a comparison between the behavior of the original smart contract and a new smart contract.

According to an embodiment of the invention, the comparison comprising:

retrieving, by the off-chain computer system, transaction data together with the original smart contract from the blockchain ledger of the blockchain computer system;

identifying, by the off-chain computer system, at least one base path of the original smart contract and accordingly creating a base path that includes an initial state of an original transaction of the identified base path;

simulating, by the off-chain computer system, a transaction using the initial state of the original transaction of the identified base path, but with instructions of the new smart contract; and

deciding, by the off-chain computer system, whether the original smart contact and the new smart contract are identical or differ in their behavior, and accordingly generating an insight.

The method according to claim 3, wherein the off-chain computer system fetches the state of the blockchain computer system by utilizing capabilities of blockchain implementations to read the state of the blockchain computer system at a given address at a given time, thereby enabling the off-chain computer system to reproduce the state of the blockchain computer system when the desired transaction was executed.

According to an embodiment of the invention, the method further comprises handling new reads in case the new smart contract performs memory reads from a memory address that the off-chain computer system does not have in the created base path, the off-chain computer system indicating the two contracts are different in the context of this specific transaction, ending the simulation, and concluding the transactions are ‘very’ different.

According to an embodiment of the invention, the method further comprises handling new reads in case the new smart contract performs memory reads from a memory address that the off-chain computer system does not have in the created base path, the off-chain computer system: attempting to calculate the value at said memory address when the transaction executed originally.

According to an embodiment of the invention, the method further comprises comparing the behaviors of two smart contracts over a great number of transactions, wherein for each transaction, the off-chain computer system determines how different the behaviors of the two contracts were in the context of that transaction, and accordingly classifying the smart contracts into categories that is used to describe how different the contracts are under the specific context of that transaction.

According to an embodiment of the invention, using the results of many transactions, the off-chain computer system determines how different the smart contracts are in a wider context of many transactions.

A non-transitory computer-readable medium comprising instructions which when executed by at least one processor causes the processor to perform the method of the invention.

### BRIEF DESCRIPTION OF THE DRAWINGS

In the drawings:

FIG. 1 schematically illustrates a system that includes a blockchain system and an off-chain system;

FIG. 2 schematically illustrates, in a block diagram form, the data extracted from a blockchain ledger of blockchain system, as well as the output provided automatically by the off-chain system as a result of comparison with a new smart contract; and

FIG. 3 is a flowchart illustrating a method for assessing future execution of a smart contract based on previous executions on a blockchain-based platform, according to an embodiment of the invention.

### DETAILED DESCRIPTION OF THE INVENTION

The core invention uses blockchain systems' ability to re-execute code of in order to test a new version of a smart contract using the transactions of another smart contract, such as an original version of a previously used smart contract.

Various terms are used throughout the description and the claims which should have conventional meanings to those with a pertinent understanding of computer programming.

Additionally, various descriptive terms are used in describing the exemplary embodiments in order to facilitate an explanation of them, and to aid one's understanding. However, while the description to follow may entail terminology which is perhaps tailored to certain computing or programming environments, such as Solidity (i.e., an object-oriented, high-level language for implementing smart contracts that is designed to be executed by a block-chain-based platform such as Ethereum) or software codes at other languages and computer systems, it will be appreciated by a person skilled in the art that such terminology is employed in a descriptive sense and not a limiting sense. Where a confined meaning of a term is intended, it will be explicitly set forth or otherwise apparent from the disclosure.

Reference will now be made to several embodiments of the present invention, examples of which are illustrated in the accompanying figures for purposes of illustration only. One skilled in the art will readily recognize from the following description that alternative embodiments of the program modules and methods described herein may be employed without departing from the principles of the invention.

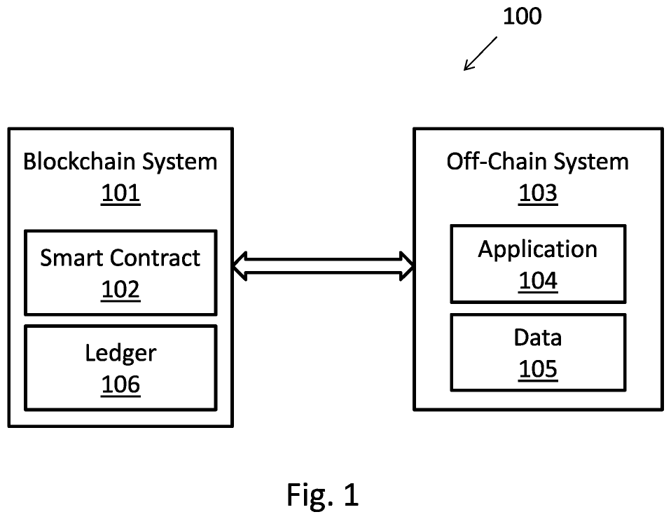

FIG. 1 schematically illustrates an example of a system 100 that includes a blockchain computer system 101 (or shortly called blockchain system) and an off-chain computer system 103 (or shortly called off-chain system) that has a mechanism to re-execute code in order to test a new version of a smart contract based on real-world inputs by using previous transactions of an already used smart contract. The blockchain system 101 is a decentralized system that may have one or more computing resources, such as one or more server computers, that are part of the blockchain system and host the well-known distributed blockchain ledger system. Each computing resource may include the well-known elements that are typically part of a computing resource such as, for example, one or more processors, memory, such as DRAM or SRAM, one or more persistent storage devices, such as flash memory or a hard disk drive, one or more databases, connectivity circuits, etc. that allow the computing resources to communicate with each other over a communications path and to host the blockchain ledger 106 and/or process or generate a block to be appended to the blockchain ledger 106. For example, the Bitcoin monetary system uses blockchain technology and the distributed ledger of the block chain system to provide a monetary system. The blockchain system 101 may further comprise one or more smart contracts 102 hosted on, stored on and/or executed by one or more computing resources that are based on the blockchain ledger 106 of the blockchain system 101. Each smart contract 102 may be a computerized transaction protocol that executes the terms of a process/protocol or contract in which the smart contract is visible to all users of the blockchain and uses the distributed blockchain ledger 106.

In system 100, the blockchain system 101 may interact with off-chain system 103. Off-chain system 103 is a system that is not part of the blockchain system 101 and does not host the distributed blockchain ledger 106. However, it is desirable to be able to permit the off-chain system 103 to interact with the blockchain system 101 in order to retrieve data from blockchain system 101 (such as actual data inputs provided to smart contract 102, the smart contract's code, and to fetch state of blockchain system 101 when the transaction was executed), in order to reproduce a transaction's execution by the off-chain system 103.

According to an embodiment of the invention, to fetch the state blockchain system 101, off-chain system 103 uses the capabilities of blockchain implementations (usually called nodes or servers). Implementations of blockchain protocols offer capabilities to read the state of the blockchain system at a given time. When a node is running in a special “archive mode”, the data can be read for any point in history since the blockchain began. An example of such functionality is Ethereum's implementation of getStorageAt, which is part of its Web3.js interface that enables developing websites or clients that interact with the blockchain—writing code that reads and writes data from the blockchain with smart contracts. This functionality allows reading the state of the blockchain system 101 at a given address at a given time (specified as a block number). Using this functionality, off-chain system 103 can reproduce the state of the blockchain system 101 when the desired transaction was executed. Other blockchain implementations have similar functionality to read previous states of the system.

The off-chain system 103 may be implemented using one or more processors, memory, such as DRAM or SRAM, one or more persistent storage devices, such as flash memory or a hard disk drive, one or more databases, connectivity circuits, etc. that allow the off-chain system 103 to store data and host applications and communicate with the blockchain system 101 over a communications path and interact with the blockchain ledger 106.

As shown in FIG. 1, the off-chain system 103 may have one or more applications/processes 104 resident on the off-chain system 103 that may perform various processes or acts or operations to re-execute code in order to test a new version of a smart contract using another's smart contract transactions. In addition, the off-chain system 103 may further have one or more data stores 105 (implemented in various manners) that may store various data retrieved from the blockchain ledger 106 of system 101 and that may be accessed by the applications/processes 104.

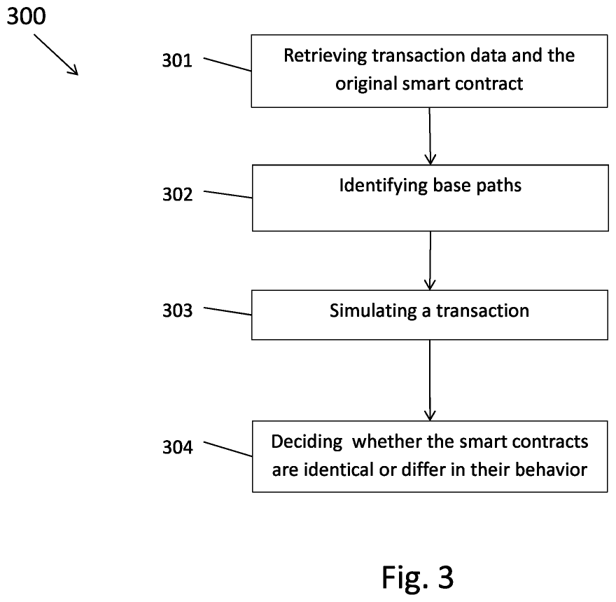

In the system 100, each of the blockchain system 101 and off-chain system 103 may, in one embodiment, have at least one processor that may be used to execute a plurality of instructions or computer code that implement the methods described below with reference to FIG. 3. In another embodiment, each of the blockchain system 101 and off-chain system 103 may have one or more pieces of hardware (an integrated circuit, microcontroller, field programmable logic circuit and the like) that implement the methods described below with reference to FIG. 3. Thus, the elements of these systems may be implemented in hardware and/or software. One element of the off-chain system 103 may be a transaction manager element that manages the interactions between the off-chain system 103 and the blockchain system 101 including executing the processes shown in FIG. 3. The transaction manager element can be part of the applications/processes 104. In addition, the transaction manager element may also coordinate the communications and data transfer protocols between the blockchain system 101 and the off-chain system 103.

The above system will be described in further details hereinafter. However, while the invention will be described in the general context of program modules or codes that execute in conjunction with an application program that runs on an operating system on a computer system that is associated with smart contracts in distributed ledger systems, those skilled in the art will recognize that the invention may also be implemented in combination with other program modules. The functions described herein may be performed by executable code and instructions stored in computer readable medium and running on one or more processor-based systems. Embodiments of the invention may be implemented as a computer process, e.g., a computer system that encodes a computer program of instructions for executing the computer process.

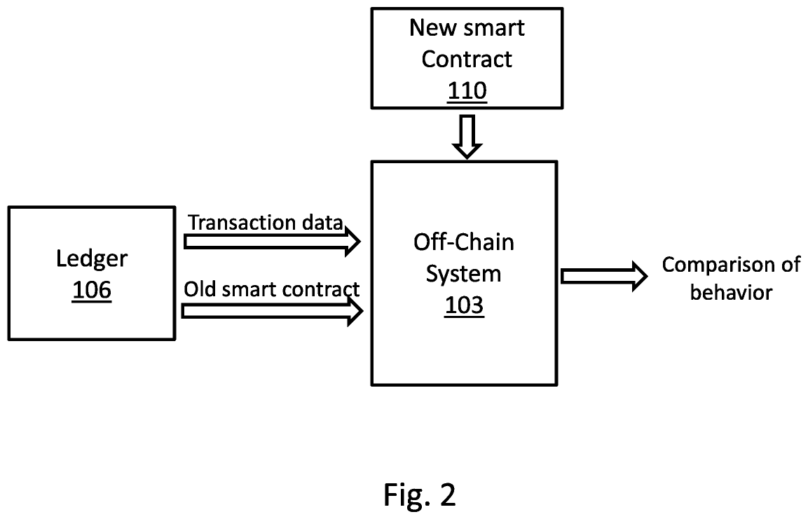

FIG. 2 schematically illustrates, in a block diagram form, the data extracted from the blockchain ledger 106 of system 101, as well as the output provided automatically by off-chain system 103 as a result of comparison with a new smart contract 110. As illustrated in this figure, off-chain system 103 retrieves from blockchain ledger 106 the transaction data and an “old” version of a smart contract.

FIG. 3 schematically illustrates an example of a comparison method 300 for a new smart contract with an off-chain system that may be performed, for example, by the system 100 shown in FIG. 1. Specifically, the comparison processes shown in FIG. 3 is automatically performed by the off-chain system 103. The comparison processes shown in FIG. 3 may be implemented in hardware and/or software. When the comparison processes are implemented in software such as applications/processes 104, the comparison processes may be a plurality of lines of instructions or computer code that may be executed by a processor associated with the off-chain system 103. Alternatively, when the registration processes are implemented in hardware, the registration processes may be performed by a microcontroller, an integrated circuit and the like that perform the processes shown in FIG. 3.

A blockchain system, such as blockchain system 101 keeps a ledger (e.g., blockchain ledger 106) of all transactions in the system as a mechanism to verify the correctness of its current state. When a new server needs to sync with the blockchain, it can rerun all the transactions to arrive at the current state. According to an embodiment of the present invention, the off-chain system 103 utilizes this data, the ledger, to rerun transactions that occurred in the past in order to use them as base paths for the analysis. When off-chain system 103 reruns a transaction, it logs all the input data, the instructions that were executed, and what data was involved in the instructions. This forms the base path for the following steps of the evaluation. Base paths are a good way to exercise smart contracts with real-world data and state, without having to create tests. This technique is most effective when the user expects the new contract to behave exactly like the old one, or has a good idea of what the differences are supposed to be. Regardless, the contracts are expected to do “basically the same thing”, so that the transactions relevant to one would also be relevant to the other. For example, a popular use case for this would be fixing a “bug” in a smart contract and expecting the behavior to remain generally the same, except for specific cases where the behavior changes.

According to an embodiment of the present invention, the comparison method may involve the following steps:

After retrieving the transaction data and the original smart contract (i.e., the “old” smart contract) from blockchain ledger 106 (step 301), identifying base paths (step 302), which are flows through the code of the smart contract that are how the system worked in the past. A base path may include the input data used to run the smart contract function, and which instructions were executed and what values were involved in the instructions.

At next, creating a base path according to identified base path. At this point off-chain system 103 creates a base path that consists of input data, the instructions that were executed along this path, and the data involved in the instructions (any state read or written). All these instructions apply to the smart contract that is deployed on the blockchain—we'll call that the “base contract”.

At next, comparing the behavior of the “base contract” to a new smart contract by using new smart contract (after being compiled), and simulating a transaction (step 303) using the same initial state as the original transaction of the identified base path, but with the new smart contract's instructions.

If the two smart contracts are identical (i.e., the “old” one and the new one), the new smart contract's transaction execution will follow exactly in the path described in the base path created by off-chain system 103. The created base path will run the same instructions and read and write the same values as done by the “old” smart contract. By the end of the execution off-chain system 103 may identify if there were no differences between the behaviors and mark the smart contracts as identical in the context of this specific transaction (step 304). That is—they behave exactly the same running this transaction at this specific time.

If the two contracts differ in behavior (step 304), the off-chain system 103 can attempt to detect the difference in their behavior. A simple case would be running different instructions that create the same output. For example, if the base contract calculated “(a*b)*c” and the new one calculates “a*(b*c)”, the instruction set (or at least the data within the instructions) would be different, but the overall effect of the transactions would be identical. They'd write and read the same data and return the same value.

Another example is a new smart contract writing different data to memory, but at the same locations as before. This could occur if the contract has a different way of calculating loan interest, for example. This smart contract would produce a different $ value and write that into an account's balance, where the “base contract” calculated a different value. The new smart contract behaves similarly to the “base contract” but produces different results.

Another possible case would be handling new reads. In the case the new smart contract performs memory reads from an address the “base contract” did not read from, the off-chain system 103 does not have in the created base path, the data that was then in that memory address when the transaction executed:

Off-chain system 103 may handle this in one of the two following ways:

1. Simply say the two contracts are different in the context of this specific transaction, end the simulation, and conclude the transactions are ‘very’ different; or

2. Attempt to calculate the value at that address when the transaction executed originally. Since this reconstruction requires executing the entire blockchain again, this could be time consuming to calculate. However, this could allow the off-chain system 103 to continue to compare smart contracts even if a new contract reads from a new address. The time-consuming reconstruction could be addressed by caching the values of memory addresses to avoid having the rebuild it from scratch. Also, when running sequentially through the blockchain to create this comparison on all transactions, the off-chain system 103 is already synced to the latest state, and reconstruction is not necessary.

Supporting reads from new addresses is important since it allows the off-chain system 103 to test cases where new functionality is added but the old behavior is still preserved. For example, a new smart contract might have a global pause flag that stops the operation of the system, but defaults to false—not paused. The new smart contract would then always read from this flag, and if the system is paused—cancel the current transaction. In this case, the smart contracts would behave nearly the same when the system is not paused—all transactions will have the same effect, with the exception of the new contract performing an extra read from the pause global flag's address. If a system can simulate this read and continue comparing transactions despite the new read, the system can provide a much more in-depth comparison of behaviors.

The following step would be summarizing results. The off-chain system 103 can follow the above steps to compare the behaviors of two smart contracts over a great number of transactions. For each transaction, the off-chain system 103 can determine how different the behaviors of the two contracts were in the context of that transaction. This could be classified into categories (such as ‘identical’, ‘different read same write’, ‘same write different data’, ‘different writes’, etc.), or another mechanism could be used to describe how different the contracts are under the specific context of that transaction.

Using the results of many transactions, the off-chain system 103 can determine how different the smart contracts are in a wider context—of many transactions. For example, if the two transactions were identical in all historical transactions—it means it would not have mattered which smart contract was deployed up to this point. This statement can provide confidence when adding new functionality to a smart contract—the user can know he hasn't changed the behavior of anything that's happened up until now.

Another example is where the differences would be a very limited number of transactions. This could indicate the smart contracts differ in only specific scenarios. This type of difference would be appropriate in the case of a bug-fix in a contract that affects only specific cases.

Finally, a change where many transactions write different data could indicate a change in how values are calculated, that affects many cases. For example, this could be a change in how loan interest is computed.

Assessing the difference between the new and old smart contract allows the user to understand the impact of upgrading the smart contract—how different it will behave once deployed—based on the history of the original smart contract. The off-chain system 103 also allows the user to identify unintended behavior changes—i.e. bugs, introduced intentionally or through human error.

An important aspect of assessing the difference in behavior between contracts is how efficient they are, that is, in the blockchain world, how much “gas” their execution requires. This same technique could be used to evaluate gas use differences in real-world transactions.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the disclosure and its practical applications, to thereby enable others skilled in the art to best utilize the disclosure and various embodiments with various modifications as are suited to the particular use contemplated.

The system and method disclosed herein may be implemented via one or more components, systems, servers, appliances, other subcomponents, or distributed between such elements. When implemented as a system, such systems may include and/or involve, inter alia, components such as software modules, general-purpose CPU, RAM, etc. found in general-purpose computers. In implementations where the innovations reside on a server, such a server may include or involve components such as CPU, RAM, etc., such as those found in general-purpose computers.

Additionally, the system and method herein may be achieved via implementations with disparate or entirely different software, hardware and/or firmware components, beyond that set forth above. With regard to such other components (e.g., software, processing components, etc.) and/or computer-readable media associated with or embodying the present inventions, for example, aspects of the innovations herein may be implemented consistent with numerous general purpose or special purpose computing systems or configurations. Various exemplary computing systems, environments, and/or configurations that may be suitable for use with the innovations herein may include, but are not limited to: software or other components within or embodied on personal computers, servers or server computing devices such as routing/connectivity components, hand-held or laptop devices, multiprocessor systems, microprocessor-based systems, set top boxes, consumer electronic devices, network PCs, other existing computer platforms, distributed computing environments that include one or more of the above systems or devices, etc.

In some instances, aspects of the system and method may be achieved via or performed by logic and/or logic instructions including program modules, executed in association with such components or circuitry, for example. In general, program modules may include routines, programs, objects, components, data structures, etc. that perform particular tasks or implement particular instructions herein. The inventions may also be practiced in the context of distributed software, computer, or circuit settings where circuitry is connected via communication buses, circuitry or links. In distributed settings, control/instructions may occur from both local and remote computer storage media including memory storage devices.

The software, circuitry and components herein may also include and/or utilize one or more type of computer readable media. Computer readable media can be any available media that is resident on, associable with, or can be accessed by such circuits and/or computing components. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM or other optical storage, magnetic tape, magnetic disk storage or other magnetic storage devices, or any other medium which can be used to store the desired information and can accessed by computing component. Communication media may comprise computer readable instructions, data structures, program modules and/or other components. Further, communication media may include wired media such as a wired network or direct-wired connection, however no media of any such type herein includes transitory media. Combinations of the any of the above are also included within the scope of computer readable media.

In the present description, the terms component, module, device, etc. may refer to any type of logical or functional software elements, circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive, etc.) to be read by a central processing unit to implement the functions of the innovations herein. Or, the modules can comprise programming instructions transmitted to a general purpose computer or to processing/graphics hardware via a transmission carrier wave. Also, the modules can be implemented as hardware logic circuitry implementing the functions encompassed by the innovations herein. Finally, the modules can be implemented using special purpose instructions (SIMD instructions), field programmable logic arrays or any mix thereof which provides the desired level performance and cost.

As disclosed herein, features consistent with the disclosure may be implemented via computer-hardware, software and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may also be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) though again does not include transitory media. Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law.

While the foregoing has been with reference to a particular embodiment of the disclosure, it will be appreciated by those skilled in the art that changes in this embodiment may be made without departing from the principles and spirit of the disclosure, the scope of which is defined by the appended claims.

1. A system, comprising:
A blockchain computer system that hosts an original smart contract and stores and maintains a blockchain ledger; and
An off-chain computer system that is not part of the blockchain system and does not store or maintain the blockchain ledger, the off-chain system is configured to automatically perform an off-chain comparison between the behavior of the original smart contract and a new smart contract;
Wherein the off-chain computer system having at least one application that is configured to retrieve transaction data together with the original smart contract from the blockchain ledger of the blockchain computer system, to identify at least one base path of the original smart contract and accordingly to create a base path that includes an initial state of an original transaction of the identified base path, to simulate a transaction using the initial state of the original transaction of the identified base path, but with instructions of the new smart contract, to decide whether the behavior of the original and new smart contracts identical or differ, and accordingly to generate an insight.

2. The system according to claim 1, in which the off-chain computer system is implemented by using one or more processors, a memory and one or more persistent storage devices that allow the off-chain computer system to store data and host one or more applications and communicate with the blockchain computer system over a communications path and interact with the blockchain ledger in order to reproduce a transaction's execution by the off-chain computer system.

3. A method, comprising:
providing a blockchain computer system that hosts an original smart contract and stores and maintains a blockchain ledger; and
providing an off-chain computer system that is not part of the blockchain system and does not store or maintain the blockchain ledger, the off-chain system having at least one an application that is configured to perform a comparison between the behavior of the original smart contract and a new smart contract.

4. The method according to claim 2, wherein the comparison comprising:
retrieving, by the off-chain computer system, transaction data together with the original smart contract from the blockchain ledger of the blockchain computer system;
identifying, by the off-chain computer system, at least one base path of the original smart contract and accordingly creating a base path that includes an initial state of an original transaction of the identified base path;
simulating, by the off-chain computer system, a transaction using the initial state of the original transaction of the identified base path, but with instructions of the new smart contract; and
deciding, by the off-chain computer system, whether the original smart contact and the new smart contract are identical or differ in their behavior, and accordingly generating an insight.

5. The method according to claim 3, wherein the off-chain computer system fetches the state of the blockchain computer system by utilizing capabilities of blockchain implementations to read the state of the blockchain computer system at a given address at a given time, thereby enabling the off-chain computer system to reproduce the state of the blockchain computer system when the desired transaction was executed.

6. The method according to claim 4, further comprising handling new reads in case the new smart contract performs memory reads from a memory address that the off-chain computer system does not have in the created base path, the off-chain computer system indicating the two contracts are different in the context of this specific transaction, ending the simulation, and concluding the transactions are ‘very’ different.

7. The method according to claim 4, further comprising handling new reads in case the new smart contract performs memory reads from a memory address that the off-chain computer system does not have in the created base path, the off-chain computer system: attempting to calculate the value at said memory address when the transaction executed originally.

8. The method according to claim 3, further comprising comparing the behaviors of two smart contracts over a great number of transactions, wherein for each transaction, the off-chain computer system determines how different the behaviors of the two contracts were in the context of that transaction, and accordingly classifying the smart contracts into categories that is used to describe how different the contracts are under the specific context of that transaction.

9. The method according to claim 3, wherein using the results of many transactions, the off-chain computer system determines how different the smart contracts are in a wider context of many transactions.

10. A non-transitory computer-readable medium comprising instructions which when executed by at least one processor causes the processor to perform the method of claim 3.
